(19) United States
(12) Patent Application Publication
(10) Pub. No.: US 2003/0177856 A1
(43) Pub. Date: Sep. 25, 2003

(54) Parking brake for a motor vehicle

(76) Inventors: Eckhard Reese, Apensen (DE); Thomas Ropke, Stelle-Ashausen (DE)

Correspondence Address: Klaus J. Bach, 4407 Twin Oaks Drive, Murrysville, PA, 15668, US

(21) Appl. No.: 10/393,310

(22) Filed: Mar. 20, 2003

(30) Foreign Application Priority Data
Mar. 22, 2002 (DE) 102 12 673.9

(51) Int. Cl. G05G 5/06

(52) U.S. Cl. 74/535

(57) ABSTRACT

In a parking brake for a motor vehicle, an operating lever is mounted pivotally on a console and an operating-lever locking pawl is mounted pivotally on the operating lever and has a second row of teeth which can be engaged in the first row of teeth for locking the parking brake. A cable-tensioning disc is rotatably mounted on a support arm which is pivotally supported on the console. An operating cable is fastened to the cable-tensioning disc such that it can be wound up by a cable-tensioning spring on the cable-tensioning disc, which is provided with a third row of teeth. A carry-along locking pawl, supported on the operating lever, has a fourth row of teeth for engagement with the third row of teeth and is pivotable between a start position in which a pilot tooth of the fourth row of teeth is disposed at a smaller distance from the third row of teeth than the other teeth of the fourth row of teeth so that it first makes contact with the teeth of the third row of teeth when the carry-along locking pawl approaches the third row of teeth.

### BACKGROUND OF THE INVENTION

The present invention relates to a parking brake for a motor vehicle, in particular for a passenger car.

EP 0 509 870 B1 discloses a parking brake for a motor vehicle, which has an actuating lever which can be actuated by means of an actuating lever and is mounted on a console, which is fixed on the vehicle in a manner such that it can pivot about a pivot axis. The console has, concentrically with the pivot axis of the actuating lever, a first row of teeth with which an actuating lever locking pawl interacts, the said locking pawl being mounted on the actuating lever in a manner such that it can pivot about a pivot axis extending parallel to the pivot axis of the actuating lever. This locking pawl has a second row of teeth and an additional tooth made of a flexible material, for example of elastomer plastic. In order to actuate the parking brake, the actuating lever is pivoted in which case the flexible additional tooth slides on the teeth of the first row of teeth of the console and thereby reduces or avoids any generation of noise. In this case, the second row of teeth of the locking pawl is disengaged from the first row of teeth of the console. In order to secure the applied brake, the second row of teeth of the locking pawl engages in the first row of teeth of the console. In this case, the additional tooth also engages in the first row of teeth, this additional tooth, however, being elastically deformed thereby.

The earlier U.S. patent application Ser. No. 10/325,435 assigned to the assignee of the present application also discloses a parking brake of the type referred to above: An actuating lever which can be actuated by means of a hand-lever or foot pedal is mounted on a console, which is fixed on the vehicle, in a manner such that it can pivot about a pivot axis. The console has, concentrically with the pivot axis of the actuating lever, a first row of teeth. An actuating-lever locking pawl is mounted on the actuating lever in a manner such that it can pivot about a pivot axis extending parallel to the pivot axis of the actuating lever and has a second row of teeth which can be engaged in the first row of teeth by pivoting of the actuating-lever locking pawl, in order to actuate the parking brake, and can be disengaged from the first row of teeth, in order to release the parking brake. Furthermore, a cable-tensioning disc is provided, which disc is mounted on a support arm in a manner such that it can pivot about a pivot axis extending parallel to the pivot axis of the actuating lever. The support arm is, for its part, mounted on the console, which is fixed on the vehicle in a manner such that it can pivot about a pivot axis extending parallel to the pivot axis of the actuating lever. A brake cable of the parking brake is fastened to the cable-tensioning disc and is fitted on the outer circumference of the cable-tensioning disc in a manner such that it can be wound up. A cable-tensioning spring drives the cable-tensioning disc in order to wind up the brake cable, as a result of which a predetermined minimum tension is always ensured in the brake cable. This cable-tensioning disc has, concentrically with its pivot axis, a third row of teeth. Furthermore, a carry-along locking pawl, which has a fourth row of teeth, is fitted on the actuating lever. When the actuating lever is actuated, the fourth row of teeth of the carry-along locking pawl engages the third row of teeth of the cable-tensioning disc and carries along the latter during the continuing pivoting adjustment of the actuating lever, as a result of which the parking brake is actuated via the brake cable.

When the actuating lever is pivoted back into its non-actuated starting position when the parking brake is released, the pivoting-back movement of the cable-tensioning disc is limited by a stop, with the result that the fourth row of teeth of the carry-along locking pawl can disengage from the third row of teeth of the cable-tensioning disc. In this state, the cable-tensioning spring can drive the cable-tensioning disc freely in order to tension or wind up the brake cable. The wear of a brake element of the parking brake and/or the effects of thermal expansion, in particular of the brake cable, may cause the cable-tensioning disc to have different rotational positions relative to the carry-along locking pawl. Since the rotation of the cable-tensioning disc naturally takes place within very small angular ranges, a relative position inevitably occurs in which the tooth tips of the teeth of the fourth row of teeth encounter the tooth tips of the teeth of the third row of teeth when the actuating lever is actuated. In this case, if there is sufficient friction the carry-along locking pawl may initially still carry the cable-tensioning disc along. However, with increasing adjustment of the actuating lever, there is an increase in the tension in the brake cable, and hence in the shearing force between the teeth standing on one another, with the result that at a sufficient pivoting adjustment of the actuating lever, a sudden adjustment of the cable-tensioning disc occurs and the fourth row of teeth abruptly engages in the third row of teeth. The relatively large forces, which are then present, may cause abrasive effects and an unpleasant generation of noise in this case. The optimum functioning of the parking brake is impaired as a result.

It is the object of the present invention to provide an improved parking brake of the type mentioned above, particularly with an improved operating mechanism of the type disclosed in U.S. application Ser. No. 10/325,435.

### SUMMARY OF THE INVENTION

In a parking brake for a motor vehicle, an operating lever is mounted pivotally on a console and an operating-lever locking pawl is mounted pivotally on the operating lever and has a second row of teeth which can be engaged in the first row of teeth for locking the parking brake. A cable-tensioning disc is rotatably mounted on a support arm which is pivotally supported on the console. An operating cable is fastened to the cable-tensioning disc such that it can be wound up by a cable-tensioning spring on the cable-tensioning disc, which is provided with a third row of teeth. A carry-along locking pawl, supported on the operating lever, has a fourth row of teeth for engagement with the third row of teeth and is pivotable between a start position in which a pilot tooth of the fourth row of teeth is disposed at a smaller distance from the third row of teeth than the other teeth of the fourth row of teeth so that it first makes contact with the teeth of the third row of teeth when the carry-along locking pawl approaches the third row of teeth.

The present invention is based on the general concept of pivotably mounting the carry-along pawl on the operating lever in such a manner that its fourth row of teeth on making contact with the third row of teeth unavoidably carries out a relative adjustment, in particular in the circumferential direction, with respect to the teeth of the third row of teeth. With such an arrangement, in the event of a tooth-on-tooth alignment between the third row of teeth and the fourth row of teeth, a relative adjustment of the fourth row of teeth inevitably takes place, such that the tooth tips of the fourth row of teeth slide away from the tooth tips of the third row of teeth, and the fourth row of teeth can engage completely and correctly the third row of teeth even before the carry-along locking pawl moves the cable-tensioning disc along in order to bring about a tensile stress in the operating cable. As a result, a harmful and possibly noisy, sudden sliding of the fourth row of teeth along the third row of teeth with the tension cable already tensioned to a greater or lesser extent is thereby avoided. This also avoids damage to the third row of teeth and/or the fourth row of teeth. Moreover, an increase in comfort for the vehicle equipped with the parking brake according to the invention is provided, since an annoying generation of noise is prevented.

In order for this forced guidance or forced adjustment of the fourth row of teeth of the carry-along locking pawl relative to the third row of teeth of the cable-tensioning disc to take place before the actual engagement of the fourth row of teeth with the third row of teeth, the carry-along locking pawl, before its fourth row of teeth makes contact with the third row of teeth of the cable-tensioning disc, is aligned in such a manner that, at least directly before contact is made between the third and the fourth row of teeth, a tooth of the fourth row of teeth, which is furthest away from the pivot axis of the carry-along locking pawl, “pilot tooth” below, is closer to the third row of teeth than the other teeth of the fourth row of teeth. This manner of construction ensures that, in every case, in particular in the tooth-on-tooth case, the pilot tooth first of all encounters a tooth of the third row of teeth and, as a result, forces the carry-along locking pawl to pivot. In this case, it is ensured that the forces required for pivoting the carry-along locking pawl are always smaller than the forces required for driving the cable-tensioning disc, with the result that the cable-tensioning disc is definitely only driven or carried along by the carry-along locking pawl if the pivoting movement of the carry-along locking pawl has caused the fourth row of teeth to be completely engaged with the third row of teeth.

According to one embodiment, the pivot axis of the carry-along locking pawl can be positioned in such a manner that the fourth row of teeth of the carry-along locking pawl moves relative to the third row of teeth of the cable-tensioning disc, in the circumferential direction thereof, when the carry-along locking pawl is pivoted. This ensures that the relative adjustment forced by contact between the third row of teeth and the fourth row of teeth always causes the teeth of the fourth row of teeth to engage in the tooth gaps of the third row of teeth.

A preferred exemplary embodiment of the invention will be described below in greater detail on the basis of the accompanying drawings in which the same reference numbers refer to identical or functionally identical components.

### BRIEF DESCRIPTION OF THE DRAWINGS

FIG. 1 is a side view of a parking brake according to the invention showing the region of a cable-tensioning disc when the parking brake is released, FIG. 2 is a view as in FIG. 1, but showing the parking brake actuated.

### DESCRIPTION OF A PREFERRED EMBODIMENT

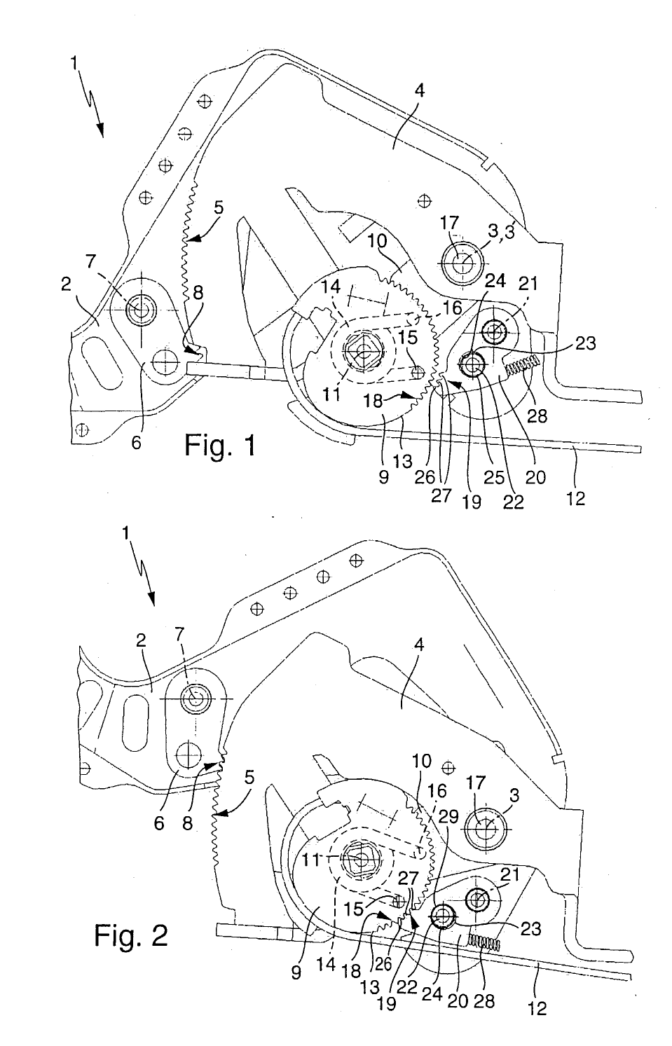

As shown in FIGS. 1 and 2, a parking brake 1 of a vehicle, in particular a passenger car, has an operating lever 2, which is only illustrated in part. In a section, which has been cut out and is not illustrated here, the operating lever 2 can be actuated by means of a hand-grip of the operating lever 2 or by means of a foot pedal (not shown). The operating lever 2 is mounted on a console 4, which is fixed on the vehicle, in a manner such that the operating lever 2 can pivot about a pivot axis 3, this pivot axis 3 extending perpendicular with respect to the plane of projection in the illustrations.

A first row of teeth 5 is formed on the console 4, the row of teeth 5 being arranged concentrically with the pivot axis 3 of the operating lever 2, that is to say that the first row of teeth 5 extends along a circular arc segment, the center point of which coincides with the pivot axis 3 of the actuating lever 2. An operating-lever locking pawl 6 is mounted pivotably on the operating lever 2, a pivot axis 7 of the actuating-lever locking pawl 6 extending parallel to the pivot axis 3 of the operating lever 2. A second row of teeth 8 is formed on the operating lever locking pawl 6, on a side disposed opposite the console 4.

In FIG. 1, the parking brake 1 is released and the operating lever 2 is in a non-actuated position. In this state, the second row of teeth 8 is situated outside the first row of teeth 5 and cannot interact therewith. In FIG. 2, the parking brake 1 is tightened or applied, that is the operating lever 2 is actuated and is pivoted about its pivot axis 3. In order to secure this pivoted position of the operating lever 2, the second row of teeth 8 is engaged in the first row of teeth 5. With the aid of a conventional release mechanism (not shown here), the operating lever locking pawl 6 can be pivoted about its pivot axis 7 in such a manner that the second row of teeth 8 disengages from the first row of teeth 5. The operating lever 2 is then released and can pivot back into the release position shown in FIG. 1, as a result of which the parking brake 1 is released.

The parking brake 1 has a cable-tensioning disc 9, which is mounted on a support arm 10 in a manner such that the disc 9 can rotate about a pivot axis 11, the pivot axis 11 of the cable-tensioning disc 9 extending parallel to the pivot axis 3 of the operating lever 2. An operating cable 12, which leads to a conventional brake element (not shown) of the parking brake, is fastened to the cable-tensioning disc 3. The operating cable 12 is arranged on the cable-tensioning disc 9 in such a manner that, when the cable-tensioning disc 9 is rotated, the operating cable winds up onto, or unwinds from, the outer circumference 13 of the disc 9. In order to drive the cable-tensioning disc 9, a cable-tensioning spring 14 is provided, of which one end engages the cable-tensioning disc 9, and the other end 16 engages the support arm 10. This cable-tensioning spring 14 biases the cable-tensioning disc 9 so as to wind up the operating cable 12 and is dimensioned in such a manner that a predetermined pre-stress is produced for the operating cable 12. This compensates for wear phenomena of the brake element and/or thermal changes in the length of the operating cable 12.

The support arm 10 is mounted in a manner such that it can pivot about a pivot axis 3, which is fixed on the vehicle and extends parallel to the pivot axis 3′ of the operating lever 2. In the present preferred embodiment, the pivot axis 3 of the supporting arm 10 coincides with the pivot axis 3′ of the operating lever 2. The support arm 10 and actuating lever 2 can, in particular, be mounted on the console 4 via a common bearing shaft 17.

The cable-tensioning disc 9 has a third row of teeth 18, which is arranged concentrically with the pivot axis 11 of the cable-tensioning disc 9. A fourth row of teeth 19, which is formed on a carry-along locking pawl 20, can interact with this third row of teeth 18. The carry-along locking pawl 20 is mounted on the operating lever 2 in a manner such that it can pivot about a pivot axis 21, which extends parallel to the pivot axis 3 of the actuating lever 2. In this case, the carry-along locking pawl 20 can be pivoted between a release position (illustrated in FIG. 1) and an engagement position (illustrated in FIG. 2). In the release position, the third row of teeth 18 and the fourth row of teeth 19 are spaced apart, with the result that the cable-tensioning disc 9 can be rotationally adjusted independently of the carry-along locking pawl 20. The release position of the carry-along locking pawl 20 is present when the operating lever 2 is not actuated (corresponding to FIG. 1) and, accordingly, the parking brake 1 is released.

In the carry-along position of the carry-along locking pawl 20, the fourth row of teeth 19 is, according to FIG. 2, engaged with the third row of teeth 18. This carry-along position is present when the operating lever 2 is pivoted in order to actuate the parking brake.

The release position and the engagement position of the carry-along locking pawl 20 are in each case defined by a stop, which is formed by a bolt 22 in the present embodiment. This bolt 22 is fitted fixedly on the operating lever 2 and protrudes from the latter parallel to the pivot axis 21 of the carry-along locking pawl 20. The carry-along locking pawl 20 includes an eye 23, through which the bolt 22 extends. According to FIG. 1, in the release position an inner rim 24 of the eye 23 bears radially against the bolt 22 on a side 25 of the bolt 22 which faces away from the fourth row of teeth 19. According to FIG. 2, in the locking position this inner rim 24 bears radially against the bolt 22, on a side 29 of the bolt 22 which faces the fourth row of teeth 19. In the locking position, large thrust forces can be transmitted by the actuating lever 2 to the cable-tensioning disc 9 via this bolt or stop 22.

The eye 23 is expediently designed as an elongated hole in the form of a segment of a circular arc with the circle center point of this elongated hole (eye 23) coinciding with the pivot axis 21 of the carry-along locking pawl 20. The inner rim 24 is matched to the outer contour of the bolt 22, so that, at least in the carry-along position, the bolt 22 bears against the inner rim 24 over a relatively large surface area.

In the preferred embodiment which is shown here, the bolt 22 is arranged closer to the third row of teeth 18 and closer to the fourth row of teeth 19 than the pivot axis 21 of the carry-along locking pawl 20. This provides, firstly, for the transmission of a high force between the actuating lever 2 and cable-tensioning disc 9 and, secondly, permits the selection of an optimum position for the pivot axis 21 of the carry-along locking pawl 20.

The position of the pivot axis 21 of the carry-along locking pawl 20 is selected in such a manner that the fourth row of teeth 19 moves relative to the third row of teeth 18, in the circumferential direction thereof, during pivoting of the carry-along locking pawl 20. Furthermore, the release position of the carry-along locking pawl 20 is selected in such a manner that a tooth 26 of the fourth row of teeth 19, which tooth is furthest away from the pivot axis 21 of the carry-along locking pawl 20 and is referred to below as pilot tooth 26, is (with the support lever 10 being in its brake-release end position) in this release position closer to the third row of teeth 18 than the other teeth 27 of the fourth row of teeth 19. This means that, in the release position of the carry-along locking pawl 20, the tooth tip of the pilot tooth 26 is, at least shortly before contact is made between the two rows of teeth 18, 19, closer to the teeth of the third row of teeth 18 than the rest of the teeth of the row of teeth 19.

Furthermore, a spring element 28 is provided which biases the carry-along locking pawl 20 into its release position.

The parking brake 1 according to the invention operates as follows:

When the parking brake 1 is completely released, the state shown in FIG. 1 is present, in which the operating lever 2 is in a rest position. In this case, the support arm 10 is in an end position, which is defined by a stop (not shown) and ensures that, in this non-actuated state, the fourth row of teeth 19 of the carry-along locking pawl 20 disengages from the third row of teeth 18 of the cable-tensioning disc 9. The cable-tensioning disc 9 is then released and can be driven by its cable-tensioning spring 14 for the purpose of pre-stressing or tightening the operating cable 12. The spring element 28 drives the carry-along locking pawl 20 into its release position, so that the eye 24 bears against that side 25 of the bolt 22, which faces away from the fourth row of teeth 19.

If the parking brake 1 is to be actuated, the operating lever 2 is pivoted. In order to be able to introduce an additional tensile force into the tension cable 12 for actuating the brake element, which is connected to the operating cable 12, the fourth row of teeth 19 has first of all to engage the third row of teeth 18. In the case of the parking brake 1 according to the invention, this process proceeds as follows:

The pivoting of the operating lever 2 causes the carry-along locking pawl 20 to move with its fourth row of teeth 19 nearer to the third row of teeth 18 of the cable-tensioning disc 9. Since the carry-along locking pawl 20 is in its start position, the invention makes provision, at least directly before the fourth row of teeth 19 makes contact with the third row of teeth 18, for a relative position to arise between these two rows of teeth 18, 19, in which position the pilot tooth 26 of the fourth row of teeth 19 is closer to the teeth of the third row of teeth 18 than the remaining teeth 27 of the fourth row of teeth 19. Accordingly, during pivoting of the actuating lever 2, this pilot tooth 26 comes first into contact with one of the teeth of the third row of teeth 18 even if it first engages in a tooth gap of the third row of teeth 18. As soon as the pilot tooth 26 bears against one of the teeth of the third row of teeth 18, the continuing pivoting movement of the actuating lever 2 forces the carry-along locking pawl 20 to be pivoted out of its start position. The teeth 26 and 27 of the fourth row of teeth 19 are then aligned such that they exactly match the teeth of the third row of teeth 18, whereby all of the teeth 26, 27 of the fourth row of teeth 19 can engage completely in the third row of teeth 18.

In the special case when the tooth tip of the pilot tooth 26 encounters a tip of a tooth of the third row of teeth 18, the forced pivoting movement of the carry-along locking pawl 20 causes the pilot tooth 26, firstly, to yield radially and, secondly, to be adjusted relative to the third row of teeth 18 in the circumferential direction of the cable-tensioning disc 9. As a result, the tooth tip of the pilot tooth 26 inevitably slides away from the respective tooth tip of the third row of teeth 18 and enters the adjacent tooth gap. This means that even in this special case, the carry-along locking pawl 20 brings about a full transmission of force to the cable-tensioning disc 9 only when the fourth row of teeth 19 is essentially completely engaged with the third row of teeth 18. An abrupt slipping of the fourth row of teeth 19 from the third row of teeth 18, and the associated high abrasion and noise generated thereby can therefore be effectively avoided even with of a tooth-on-tooth position between the two rows of teeth 18, 19.

The dimensioning of the spring element 28 is selected in such a manner that the biasing force obtained therewith is many times smaller than the actuating force introduced into the carry-along locking pawl 20 via the actuating lever 2. For example, the biasing force produced by the spring element 28 is approximately 20 N or less; in particular, the spring pre-stress is selected from a range of between 5 N and 15 N. The pivoting angle of the carry-along locking pawl 20 may also be selected such that it is comparatively small, with the result that the carry-along locking pawl 20 moves, for example approximately between 3° and 5° between its start position and its carry-along position.

1. A parking brake for a motor vehicle, comprising:
a console (4) mounted on said motor vehicle,
an operating lever (2) supported on said console (4), pivotally about a pivot axis (3),
said console (4) having a first row of teeth (5) arranged, concentrically with the pivot axis (3) of the operating lever (2),
an operating-lever locking pawl (6) mounted on the operating lever (2) so as to be pivotable about a pivot axis (7) extending parallel to the pivot axis (3) of said operating lever (2) and having a second row of teeth (8) for engagement with the first row of teeth (5) by pivoting of the operating lever (2), in order to actuate the parking brake (1),
a cable-tensioning disc (9) supported on a support arm (10) so as to be rotatable about a pivot axis (11) extending parallel to the pivot axis (3) of said operating lever (2),
said support arm (10) being mounted pivotably about a pivot axis (3′) which extends parallel to the pivot axis (3) of the operating lever (2) and is fixed with respect to the vehicle,
an operating cable (12) fastened to the cable-tensioning disc (9) for being wound upon the tensioning disc (9),
a cable-tensioning spring (14) biasing the cable-tensioning disc (9) in an operating cable wind up direction,
the cable-tensioning disc (9) having, concentrically with its pivot axis (11), a third row of teeth (18),
a carry-along locking pawl (20), supported on the operating lever (2), and having a fourth row of teeth (19) which, when the operating lever (2) is actuated, engages the third row of teeth (18) and, when the operating lever (2) is not actuated, is disengaged from the third row of teeth (18),
said carry-along locking pawl (20) being mounted on the operating lever (2) so as to be pivotable between a start position in which said third row of teeth (18) and the fourth row of teeth (19) are not in contact with each other, and a carry-along position in which the fourth row of teeth (19) is engaged with the third row of teeth (18),
said fourth row of teeth including a pilot tooth (26), at the end of the fourth row of teeth (19) furthest away from the pivot axis (21) of the carry-along locking pawl (20) and disposed at least directly ahead of the fourth row of teeth (19) and spaced from the third row of teeth (18) by a smaller distance than the other teeth (27) of the fourth row of teeth (19).

2. A parking brake according to claim 1, wherein the engagement position of the carry-along locking pawl (20) is selected in such a manner that the fourth row of teeth (19) engaged in the third row of teeth (18) extends along an arc concentrically with the pivot axis (11) of the cable-tensioning disc (9).

3. A parking brake according to claim 1, wherein the pivot axis (21) of the carry-along locking pawl (20) is positioned in such a manner that the fourth row of teeth (19) moves in the circumferential direction relative to the third row of teeth (18) when the carry-along locking pawl (20) is pivoted.

4. A parking brake according to claim 1, wherein the start position and the engagement position of the carry-along locking pawl (20) are defined by a stop (23).

5. A parking brake according to claim 4, wherein the stop is formed by a bolt (22) which is fixed to the actuating lever (2), protrudes from the latter parallel to the pivot axis (21) of the carry-along locking pawl (20) and extends through an eye (23), which is formed in the carry-along locking pawl (20), and permits limited pivot movement of the locking pawl (20) between the starting position, in which a wall portion (24) of the eye (23) bears radially against the bolt (22) on a side (25) facing away from the fourth row of teeth (19) and, in the engagement position, bears radially against the bolt (22) on a side (29) facing the fourth row of teeth (19).

6. A parking brake according to claim 5, wherein the eye (23) is an elongated hole in the shape of a segment of a circular arc, the circle center point of which lies in the pivot axis (21) of the carry-along locking pawl (20).

7. A parking brake according to claim 5, wherein the bolt (22) is arranged closer to the third and fourth rows of teeth (18) than the pivot axis (21) of the carry-along locking pawl (20).

8. A parking brake according to claim 1, wherein the carry-along locking pawl (20) is biased by a spring element (28) into the start position.

9. A parking brake according to claim 8, wherein the spring element (28) is pre-stressed to provide a pre-stress force of not more than 20 N.

10. A parking brake according to claim 1, wherein the carry-along locking pawl (20) has a pivot range of approximately 5° or less between its start position and its engagement position.
